(19) United States
(12) Patent Application Publication
(10) Pub. No.: US 2026/0238512 A1
(43) Pub. Date: Aug. 13, 2026

(54) DEPLOYMENT OF REDUNDANCY BOX FUNCTIONALITY IN A SOFTWARE-DEFINED NETWORK

(71) Applicant: Schweitzer Engineering Laboratories, Inc., Pullman, WA (US)

(72) Inventors: Daniel B. Rippon, Pullman, WA (US); Rhett Smith, Odessa, FL (US); Ryan Bradetich, Pullman, WA (US)

(73) Assignee: Schweitzer Engineering Laboratories, Inc., Pullman, WA (US)

(21) Appl. No.: 19/050,396

(22) Filed: Feb. 11, 2025

(51) Int. Cl. H04L 12/437; H04L 41/122

(52) U.S. Cl. CPC H04L 12/437; H04L 41/122

(57) ABSTRACT

The present disclosure relates to implementing a Redundancy Box (“RedBox”) functionality in a software-defined network (“SDN”). In one embodiment, a configuration subsystem may identify at least one singly attached node (“SAN”) in the SDN and identify at least one dually attached node (“DAN”) in the SDN. The configuration subsystem may generate a first subset of a plurality of communication flows to implement RedBox functionality for communications between at least one SAN and at least one DAN

### TECHNICAL FIELD

The present disclosure pertains to systems and methods for implementing a redundancy box in a software-defined network (“SDN”). More particularly, but not exclusively, systems and methods consistent with the present disclosure may be utilized in conjunction with Parallel Redundancy Protocol (“PRP”) and High-availability Seamless Redundancy (“HSR”).

### BRIEF DESCRIPTION OF THE DRAWINGS

Non-limiting and non-exhaustive embodiments of the disclosure are described, including various embodiments of the disclosure, with reference to the figures, in which:

FIG. 1 illustrates a conceptual representation of an SDN system, including a control plane, a data plane, and a plurality of data consumer/producer devices consistent with embodiments of the present disclosure.

FIG. 2 illustrates a functional block diagram of an SDN system implementing software-defined redundancy boxes consistent with the present disclosure.

FIG. 3 illustrates a block diagram of a system including an SDN controller, an SDN comprising a plurality of network devices, and a plurality of hosts consistent with embodiments of the present disclosure.

### DETAILED DESCRIPTION

In an SDN, a controller may regulate communications on the network. SDN networking technologies offer a variety of advantages, such as deny-by-default security, latency guarantees, deterministic transport capabilities, redundancy, and fail-over planning, etc. An SDN enables a programmatic change control platform, which allows an entire communication network to be managed as a single asset, simplifies the understanding of the network, and enables continuous network monitoring. In an SDN, the systems that decide where the traffic is sent (i.e., the control plane) are separated from the systems that perform the forwarding of the traffic in the network (i.e., the data plane).

An SDN controller provides centralized configuration and situational awareness. It may perform topology discovery, circuit provisioning, and telemetry monitoring. The control plane has three main components: a match component, an action component, and a counter component. The match component determines which control plane rules to apply to each packet entering a switch port. After the flow match determination, the action component instructs the switch regarding what it does with the packet. The counter component includes metrics that may be used to monitor the overall status and health of the network. The counter component may be used in connection with a variety of functions (e.g., alarming on bandwidth when a communication channel gets close to saturation, providing metrics (e.g., counters and meters for quality of service, packet counts, errors, drops, or overruns, etc.) for a specified flow, etc.).

The control plane may be used to optimize or customize the usage of network resources by creating specific data flows through the communication network. A data flow, as the term is used herein, refers to a set of parameters used to match and take action based on network packet contents.

SDN offers considerable advantages in high-reliability applications. Such advantages may be furthered by utilizing PRP or HSR systems. PRP is a network protocol standard for Ethernet that provides redundancy and protects against single points of failure. PRP is frequently utilized in conjunction with redundant network architectures. One example of a redundant network architecture that may be utilized in connection with a PRP or HSR system is a ring architecture. A PRP-enabled device has two communication ports, each of which is attached to a separate local area network (“LAN”). Source nodes send two copies of each packet, one over each network resulting in redundant packets and redundant networks. When a destination node receives a packet, it accepts the first copy and discards the second copy, eliminating the duplicate. To avoid a single point of failure, the two LANs may use distinct physical links and thus may be assumed to be fail-independent. As long as one path is operational, the destination application receives at least one of the redundant transmissions. Source nodes in an HSR architecture have two network interfaces and publish two packets, but both interfaces and both packets are sent into a single network through physically distinct paths to the destination.

High reliability and redundant communication networks offer advantages that may be utilized in an infrastructure system (e.g., electric power systems, telecommunication systems, etc.), manufacturing systems, alarm systems, and various other applications.

While SDN offers numerous advantages, complications also arise, including incorporating devices not designed or configured for PRP or HSR. Many devices, including those used in the systems described above, are designed to have a single connection point to a network. A redundancy box (“RedBox”) is typically used to address this scenario. A RedBox normally includes at least three ports: two ports to connect to the redundancy network architecture of PRP or HSR and a third port to connect to the device that does not natively support communication on the redundant network architecture. Devices that connect to a single LAN (without the use of a RedBox) are referred to herein as Singly Attached Nodes (“SANs”). Devices that connect to two LANs are referred to as Dually Attached Nodes (“DANs”). Incorporating a SAN into a PRP or HSR network requires conversion technology, additional configuration, and typically requires additional hardware (i.e., a RedBox).

Embodiments consistent with the present disclosure utilize SDN technology to implement the functionality of a RedBox. Such embodiments may offer a variety of advantages. For example, such embodiments may provide additional flexibility and improve utilization. Embodiments consistent with the present disclosure may allow a SAN to connect to any port on an SDN, and appropriate data flows may be created to convert the traffic between SAN and DAN handling redundant packets. Moreover, such embodiments are not constrained by the location or number of ports on specific devices. A SAN may be attached to any port in the SDN. Further, RedBox functionality may be implemented in existing SDN networks without changes to network topology or introducing new hardware.

Various embodiments consistent with the present disclosure may also operate in conjunction with software programs to configure data flows and manage an SDN. Such software enables flexible configuration of each communications flow path and the ability to proactively engineer fault-tolerant networks, resulting in greater performance, improved reliability, and more deterministic packet delivery. In some embodiments, a software platform may automatically generate appropriate data flows for RedBox functionality without user intervention by identifying a SAN and DAN needing to communicate with each other. Such programs may offer a user a range of options regarding the configuration, from a simplified configuration generated with little or no user intervention to an entirely manual configuration in which a user creates all data flows.

The embodiments of the disclosure will be best understood by reference to the drawings, wherein like parts are designated by like numerals throughout. It will be readily understood that the components of the disclosed embodiments, as generally described and illustrated in the figures herein, could be arranged and designed in various configurations. Thus, the following detailed description of the embodiments of the systems and methods of the disclosure is not intended to limit the scope of the disclosure, as claimed, but is merely representative of possible embodiments of the disclosure. In addition, the steps of a method do not necessarily need to be executed in any specific order or even sequentially, nor need the steps be executed only once unless otherwise specified.

In some cases, well-known features, structures, or operations are not shown or described in detail. Furthermore, the described features, structures, or operations may be combined in any suitable manner in one or more embodiments. It will also be readily understood that the components of the embodiments, as generally described and illustrated in the figures herein, could be arranged and designed in a wide variety of different configurations.

Several aspects of the embodiments described may be implemented as software modules or components. As used herein, a software module or component may include any computer instruction or computer-executable code located within a memory device and/or transmitted as electronic signals over a system bus or wired or wireless network. For instance, a software module or component may comprise one or more physical or logical blocks of computer instructions, which may be organized as a routine, program, object, component, data structure, etc., that performs one or more tasks or implements particular abstract data types.

In certain embodiments, a particular software module or component may comprise disparate instructions stored in different locations of a memory device, which together implement the described functionality of the module. Indeed, a module or component may comprise a single instruction or many instructions and may be distributed over several code segments, among different programs, and across several memory devices. Some embodiments may be practiced in a distributed computing environment where tasks are performed by a remote processing device linked through a communications network. Software modules or components may be located in local and/or remote memory storage devices in a distributed computing environment. In addition, data being tied or rendered together in a database record may be resident in the same memory device or across several memory devices and may be linked together in fields of a record in a database across a network.

Embodiments may be provided as a computer program product, including a non-transitory computer and/or machine-readable medium having stored thereon instructions that may be used to program a computer (or another electronic device) to perform processes described herein. For example, a non-transitory computer-readable medium may store instructions that, when executed by a processor of a computer system, cause the processor to perform certain methods disclosed herein. The non-transitory computer-readable medium may include but is not limited to, hard drives, floppy diskettes, optical disks, CD-ROMs, DVD-ROMs, ROMs, RAMs, EPROMs, EEPROMs, magnetic or optical cards, solid-state memory devices, or other types of machine-readable media suitable for storing electronic and/or processor-executable instructions.

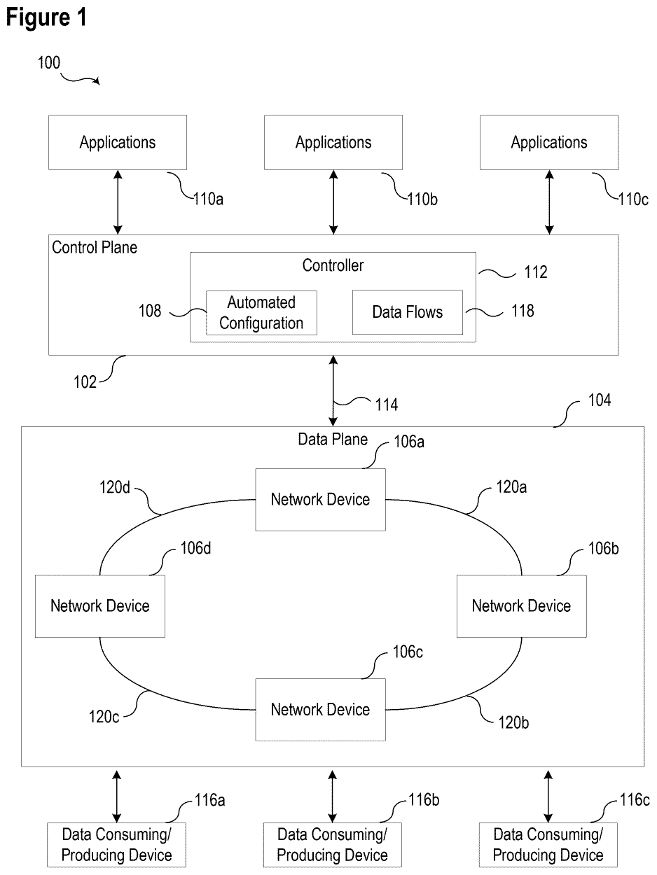

FIG. 1 illustrates a conceptual representation of an SDN system 100, including a control plane 102, a data plane 104, and a plurality of data consumer/producer devices 116a-116c consistent with embodiments of the present disclosure. The control plane 102 directs a plurality of data flows through the data plane 104. A controller 112 may communicate with a plurality of network devices 106a-106d via an interface 114 to establish data flows between devices. Controller 112 may specify rules for routing traffic through data plane 104 based on various criteria.

Each network device 106a-106d may implement and store a plurality of data flows. In one specific embodiment, the data flows may be stored in or implemented by a Field Programmable Gate Array (FPGA). An FPGA may offer both the configurability and speed suitable for SDN applications. The data flows may be received from the controller 112. Alternatively, some embodiments may be implemented using an application-specific integrated circuit (ASIC) or a general-purpose processor. In embodiments utilizing a general-purpose processor, suitable software may be used to cause the general-purpose processor to implement the functions and methods described herein.

The data plane 104 includes a plurality of network devices 106a-106d in communication with one another via a plurality of physical links 120a-120d. In various embodiments, network devices 106a-106d may be embodied as switches, multiplexers, and other types of network devices. The physical links 120a-120d may be embodied as Ethernet, fiber optic, and other forms of data communication channels. As illustrated, the physical links 120a-120d between the network devices 106a-106d may provide redundant connections such that a failure of one of the physical links 120a-120d is incapable of completely blocking communication with an affected network device. In some embodiments, the physical links 120a-120d may provide an N-1 redundancy or better. A ring architecture, as illustrated in FIG. 1, is commonly used with the HSR protocol. In such an architecture, a first packet may be communicated in a clockwise direction, while a second packet is communicated in a counterclockwise direction. If both copies of a packet arrive at a destination, the later-arriving redundant copies may be identified and discarded.

The data consuming/producing devices 116a-116c may represent a variety of devices within that produce or consume data. For example, data-consuming/producing devices 116a-116c may be embodied as a pair of transmission line relays configured to monitor an electrical transmission line. The transmission line relays may monitor various aspects of the electric power flowing through the transmission line (e.g., voltage measurements, current measurements, phase measurements, synchrophasors, etc.) and may communicate the measurements to implement a protection strategy for the transmission line. Traffic between the transmission line relays may be routed through the data plane 104 using a plurality of data flows 118 implemented by controller 112. A wide range of devices consistent with embodiments of the present disclosure may embody data-consuming/producing devices 116a-116c.

Applications 110a-110c may represent a variety of applications operating in an applications plane. In the SDN architecture illustrated in FIG. 1, controller 112 may expose an application programming interface (API) that applications 110a-110c can use to configure the data plane 104. In addition to an API, other mechanisms may be used to configure the data plane 104. Controller 112 may interface with the data plane 104 and identify communication flows while the control logic resides in the applications 110a-110c. The configuration of controller 112 and applications 110a-110c may be tailored to meet a wide variety of specific needs. Some needs may be specific to electric power systems because of requirements to conform to standards set by various authorities. Such standards may include standards associated with critical infrastructure, as identified by the United States Cybersecurity & Infrastructure Security Agency (CISA).

Data consuming/producing devices 116a-116c may transmit information using network devices 106a-106d. The data from data consuming/producing devices 116a-116c may be routed by data plane 104 according to the plurality of data flows 118 specified by controller 112. Network devices 106a-106d may comprise switches, routers, and other equipment to transmit data through data plane 104.

Controller 112 may implement various features and methods described herein to reduce the burden associated with the configuration and operation of system 100. In various embodiments, controller 112 may detect changes in the addresses of devices (e.g., data consuming/producing devices 116a-116c, network devices 106a, 106b, 106c, 106c, etc.) in system 100.

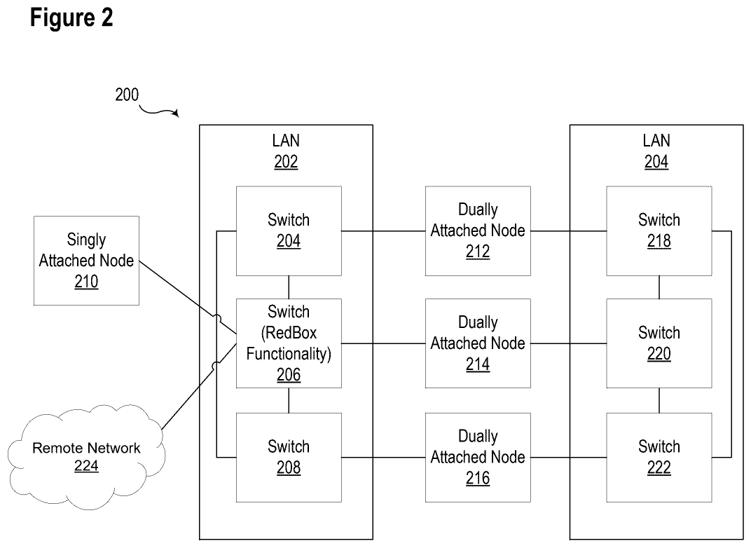

FIG. 2 illustrates a block diagram of a system 200 comprising two LANs 202 and 204, which are connected to a plurality of dually attached nodes 212, 214, 216, and a singly attached node 210 consistent with embodiments of the present disclosure. In some embodiments, DANs 212, 214, 216, and SAN 210 may be embodied as protective relays in an electric power system.

System 200 may implement PRP, and as such, redundant messages may be transmitted by both LAN 202 and LAN 204. For example, a packet originating from DAN 212 and addressed to DAN 216 may be sent to switch 204 and switch 218. The packet forwarded to switch 204 may then be routed through switch 206 and switch 208. Similarly, the packet forwarded to switch 218 may be routed through switch 220 and switch 222. DAN 216 may receive duplicate copies of the packet. DAN 216 may use the first copy of the packet to arrive and discard the later received second copy. The architecture of LAN 202 and LAN 204 provides at least two paths to each switch. For example, switch 218 is in communication with switch 220 and switch 222. As a result of this architecture, each of LAN 202 and LAN 204 may continue to operate despite the failure of a physical communication link, thus providing an N-1 redundancy.

SAN 210 is connected to switch 206, which is implementing RedBox functionality. Communication flows implemented in system 200 may be configured to eliminate redundant packets destined for SAN 210. Although switch 206 is the only switch illustrated as implementing RedBox functionality, any other switch could be configured with appropriate communication flows to implement RedBox functionality. Such functionality enables greater flexibility in the design of networks and the inclusion of SANs. In addition to avoiding the cost of dedicated RedBox hardware, embodiments consistent with the present disclosure may also facilitate the configuration of system 200. Still further, although only one SAN is illustrated, a plurality of SANs may be connected to systems consistent with the present disclosure. In such embodiments, communication flows may enable communication between DANs and SANs and may also enable communication between SANs.

A remote network 224 may be in communication with switch 206. In various embodiments, remote network 224 may utilize PRP or HSR; however, the connection 226 between remote network 224 and system 200 may be connected to switch 206 using RedBox functionality. Remote network 224 may comprise multiple LANs, DANs, and SANs. In other words, in some embodiments, a SAN may comprise a communication channel with a portion of a remote network. Although such a communication channel may be a single point of failure, redundant communications using PRP or HSR may be utilized in other portions of system 200.

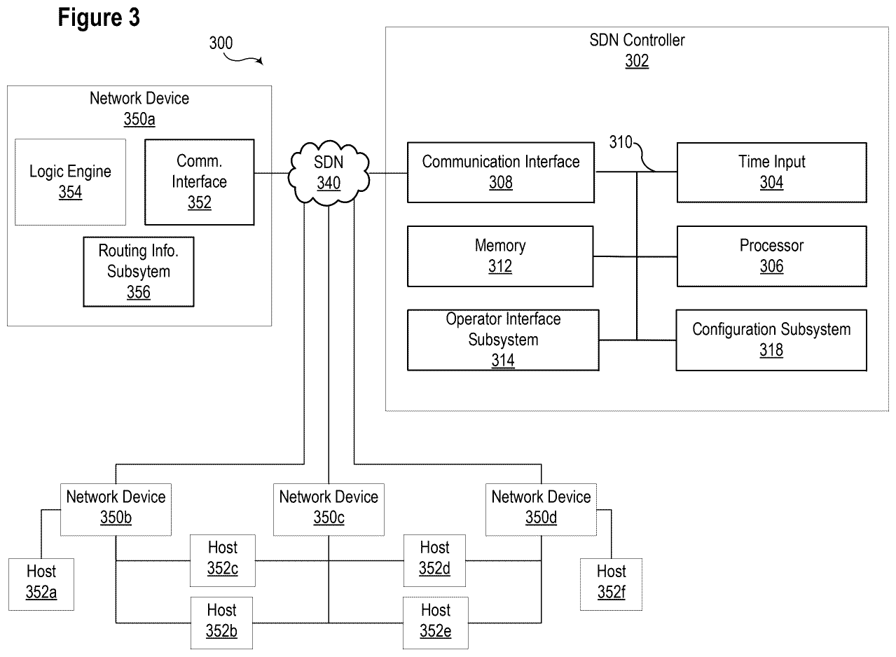

FIG. 3 illustrates a block diagram of a system 300, including an SDN controller 302, an SDN 340 comprising a plurality of network devices 350a-d, and a plurality of hosts 352a-352f consistent with embodiments of the present disclosure. In some embodiments, system 300 may be implemented using hardware, software, firmware, and/or any combination thereof. Moreover, certain components or functions described herein may be associated with other devices or performed by other devices 352a-f. The specifically illustrated configuration merely represents one embodiment consistent with the present disclosure.

SDN controller 302 includes a communication interface 308 configured to communicate with SDN 340 and network devices 350a-d. Communication interface 308 may facilitate communications with multiple devices and comprise more than one physical interface. SDN controller 302 may further include a time input 304, which may be used to receive a time signal (e.g., a common time reference), allowing SDN controller 302 to apply a time stamp to received data. In certain embodiments, a common time reference may be received via communication interface 308, and accordingly, a separate time input may not be required. One such embodiment may employ the IEEE 1588 protocol. A data bus 310 may facilitate communication among various components of SDN controller 302.

Processor 306 may be configured to implement instructions related to the systems and methods described herein. Processor 306 may process communications received via communication interface 308 and may coordinate the operation of the other components of SDN controller 302. Processor 306 may operate using any number of processing rates and architectures. Processor 306 may be configured to perform any of the algorithms and calculations described herein. Processor 306 may be embodied as a general-purpose integrated circuit, an application-specific integrated circuit, a field-programmable gate array, and/or any other suitable programmable logic device.

Memory 312 may store instructions to be executed by processor 306. Memory 312 may comprise random access memory (RAM) and non-volatile storage. Memory 312 may be in communication with processor 306 using bus 310. Instructions stored by memory 312 may include the processes and algorithms disclosed herein related to routing and processing data packets with SDN 340.

An operator-interface subsystem 314 may receive various types of information relating to configuring SDN 340 from an operator. In some embodiments, the operator-interface subsystem 314 may facilitate the establishment of a planned configuration. Operator-interface subsystem 314 may allow operators to establish and modify data flows between hosts 352a-352f, enable or disable various types of communication, implement failover contingencies, etc. Still further, operator-interface subsystem 314 may also provide alerts related to changes in SDN 340 and/or other connected devices, such as hosts 352a-352f. Such alerts may help to ensure that the operator maintains control over the configuration of system 300.

Configuration subsystem 318 may be configured to generate a variety of communication flows in SDN 340. The configuration subsystem 318 may specify the configuration of various intermediate devices (e.g., routers, switches, multiplexers, etc.), connecting communicating hosts. Configuration subsystem 318 may implement traffic flows corresponding to a planned configuration of system 300. In the illustrated embodiment, hosts 352a and 352f are SANs, and hosts 352b, 352c, 352d, and 352e are DANs. Configuration subsystem 318 may be configured to identify the components and topology in system 300. Further, configuration subsystem 318 may generate appropriate data flows to enable the operation of equipment in system 300. For example, network devices 350b and 350c may comprise relays that monitor an electric power line. The relays may exchange data about electrical parameters at each end of the transmission line. As such, configuration subsystem 318 may automatically establish a data flow between network device 350b and network device 350c to enable the proactive function.

Network device 350a is illustrated in greater detail than the other network devices 350b-c; however, network devices 350b-350d may include some or all of the same features and elements. Each of the network devices 350a-d may include a communication interface 352, a logic engine 354, and a routing information subsystem 356. The communication interface 352 may facilitate communications with multiple devices, including one or more hosts and SDN controller 302. In various embodiments, the communication interface 352 may be configured to communicate via a variety of communication links, including Ethernet, fiber optic, and other forms of data communication channels.

Routing information subsystem 356 may be configured to implement a plurality of communication flows received from SDN controller 302. In some embodiments, the routing information subsystem may include a routing table, a routing information base, a forwarding table, etc.

Logic engine 354 may analyze data processed by network device 350a. If the data matches an established communication flow, such data may be routed by network device 350a consistent with the communication flow. If a packet fails to match an established communication flow, the packet may be transmitted to SDN controller 302 for analysis or other action. In various embodiments, logic engine 354 may be implemented using an FPGA, an ASIC, or a general-purpose processor. Such embodiments may allow network device 350a to rapidly process customized communication flows and identify redundant data packets.

While specific embodiments and applications of the disclosure have been illustrated and described, it is to be understood that the disclosure is not limited to the precise configurations and components disclosed herein. Accordingly, many changes may be made to the details of the above-described embodiments without departing from the underlying principles of this disclosure. The scope of the present invention should, therefore, be determined only by the following claims.

What is claimed is:

1. A system to implement a Redundancy Box (“RedBox”) functionality in a software-defined network (“SDN”), comprising:
a configuration subsystem to:
identify at least one singly attached node (“SAN”) in the SDN;
identify at least one dually attached node (“DAN”) in the SDN;
generate a first subset of a plurality of communication flows to implement RedBox functionality by one of a plurality of network devices in the SDN and to convert traffic directed between the at least one SAN and the at least one DAN in the SDN; and
generate a second subset of communication flows to implement a redundant protocol for traffic directed to the at least one DAN in the SDN sourced by a SAN and to convert traffic directed to the at least one DAN using a redundant protocol; and
a communication interface to communicate the plurality of communication flows to the plurality of network devices in the SDN.

2. The system of claim 1, wherein the redundant protocol comprises a Parallel Redundancy Protocol.

3. The system of claim 1, wherein the redundant protocol comprises a High-availability Seamless Redundancy (HSR) protocol.

4. The system of claim 1, wherein the plurality of network devices in the SDN each comprises a network switch.

5. The system of claim 1, wherein the configuration subsystem is further configured to identify the SAN without user intervention.

6. The system of claim 1, wherein the configuration subsystem is further configured to generate the first subset of the plurality of communication flows without user intervention.

7. The system of claim 1, wherein each port of the plurality of network devices is individually configurable to implement the RedBox functionality and to enable communications between at least one SAN and the at least one DAN.

8. The system of claim 1, wherein the first subset of communication flows are configured to identify and selectively discard redundant communication packets to be delivered to the at least one SAN.

9. The system of claim 1, wherein the plurality of communication flows are further configured to enable communication between at least two SANs.

10. The system of claim 1, wherein the at least one SAN comprises of a communication channel with a portion of a remote network.

11. A method of implementing a Redundancy Box (“RedBox”) functionality in a software-defined network (SDN), comprising:
identifying, using a configuration subsystem, at least one singly attached node (SAN) in the SDN;
identifying, using the configuration subsystem, at least one dually attached node (DAN) in the SDN;
generating, using the configuration subsystem, a first subset of a plurality of communication flows to implement RedBox functionality by one of a plurality of network devices in the SDN and in communication with the SAN;
generating, using the configuration subsystem, a second subset of communication flows to implement a redundant protocol for traffic directed between the at least one DAN and the at least one SAN.

12. The method of claim 11, wherein the redundant protocol comprises a Parallel Redundancy protocol.

13. The method of claim 11, wherein the redundant protocol comprises a High-availability Seamless Redundancy protocol.

14. The method of claim 11, wherein the plurality of network devices in the SDN each comprises a network switch.

15. The method of claim 11, wherein the configuration subsystem is further configured to identify the SAN without user intervention.

16. The method of claim 11, wherein the configuration subsystem is further configured to generate the first subset of the plurality of communication flows without user intervention.

17. The method of claim 11, wherein each port of the plurality of network devices is individually configurable to implement the RedBox functionality and enable communications between the at least one SAN and the at least one DAN.

18. The method of claim 11, further comprising configuring the first subset of communication flows to identify traffic sourced from the at least one DAN and selectively discard redundant communication packets to be delivered to the at least one SAN.

19. The method of claim 11, wherein the plurality of communication flows are further configured to enable communication between at least two SANs.

20. The method of claim 11, wherein the at least one SAN comprises a portion of a communication channel with a portion of a remote network.
